(19) United States
(12) Patent Application Publication
(10) Pub. No.: US 2008/0107933 A1
(43) Pub. Date: May 8, 2008

(54) Fuel cell hibernation mode method and apparatus

(76) Inventor: Emerson R. Gallagher, Vancouver (CA)

Correspondence Address: SEED INTELLECTUAL PROPERTY LAW GROUP PLLC, 701 FIFTH AVE, SUITE 5400, SEATTLE, WA, 98104, US

(21) Appl. No.: 11/592,700

(22) Filed: Nov. 2, 2006

(51) Int. Cl. H01M 8/04; H01M 10/44; H02J 7/00

(52) U.S. Cl. 429/17; 429/22; 320/101

(57) ABSTRACT

A system and method for operating a power system with a fuel cell stack and a power source are disclosed. Briefly described, one embodiment is a method that halts a flow of an oxidant to the first fuel cell stack in response to at least one of a power demand of the power system or a load supplied to a power system being less than a threshold, wherein the first amount of power decreases as a residual amount of oxidant in the first fuel cell stack is reacted; operates a fuel recirculation system to recirculate a flow of a fuel to the first fuel cell stack at least during at least a portion of a period while the flow of the oxidant to the first fuel cell stack is halted; and replaces the decreased first amount of power with a corresponding second amount of power from the second power source.

### BACKGROUND OF THE INVENTION

1. Field of the Invention

This disclosure generally relates to fuel cell systems suitable for producing electrical power.

2. Description of the Related Art

Electrochemical fuel cells convert fuel and oxidant to electricity. Solid polymer electrochemical fuel cells generally employ a membrane electrode assembly (“MEA”) which includes an ion exchange membrane or solid polymer electrolyte disposed between two electrodes typically comprising a layer of porous, electrically conductive sheet material, such as carbon fiber paper or carbon cloth. The MEA contains a layer of catalyst, typically in the form of finely comminuted platinum, at each membrane electrode interface to induce the desired electrochemical reaction. In operation, the electrodes are electrically coupled for conducting electrons between the electrodes through an external circuit. Typically, a number of MEAs are electrically coupled in series to form a fuel cell stack supplying a desired power output.

In typical fuel cells, the MEA is disposed between two electrically conductive fluid flow field plates or separator plates. Fluid flow field plates have flow passages to direct fuel and oxidant to the electrodes, namely the anode and the cathode, respectively. The fluid flow field plates act as current collectors, provide support for the electrodes, provide access channels for the fuel and oxidant, and provide channels for the removal of reaction products, such as water formed during fuel cell operation. The fuel cell system may use the reaction products in maintaining the reaction. For example, reaction water may be used for hydrating the ion exchange membrane and/or maintaining the temperature of the fuel cell stack.

Fuel cell stacks are typically designed for maximum power conditions. In existing fuel cell systems, flow is increased at idle power conditions to provide enough pressure drop for water management. The flows required to generate this pressure drop at idle power conditions are large (with respect to the required stoichiometry, stoichiometry being the ratio of fuel or oxidant supplied to that consumed in the generation of electrical power in the fuel cell) and significantly reduce the efficiency of the fuel cell system. Attempts have been made to reduce these flows and pressure drops, but these attempts decrease the robustness and reliability of the fuel cell stack under idle conditions. A fuel cell system that is robust, reliable and efficient under both maximum and idle power conditions would be highly desirable.

### BRIEF SUMMARY OF THE INVENTION

In one aspect, a method is disclosed for operating a power system comprising at least a first power source and a second power source, wherein the first power source and the second power source are electrically coupled in parallel to one another via a direct current (DC) power bus, wherein the first power source is a first fuel cell stack, and wherein a cathode of the first fuel cell stack is coupled to a positive DC voltage portion of the DC power bus via a first diode. The method comprises halting a flow of an oxidant to the first fuel cell stack in response to at least one of a power demand of the power system or a load supplied to a power system being less than a threshold, wherein the first amount of power decreases as a residual amount of oxidant in the first fuel cell stack is reacted; operating a fuel recirculation system to recirculate a flow of a fuel to the first fuel cell stack-at least during at least a portion of a period while the flow of the oxidant to the first fuel cell stack is halted; and replacing the decreased first amount of power with a corresponding second amount of power from the second power source.

In another aspect, the power system comprises a direct current (DC) bus with a positive DC voltage rail; a first power source; a second power source electrically coupled to the DC bus and operable to output a second amount of power to the load; and a controller controllably coupled to the oxidant supply valve and the fuel recirculation valve, and operable to close the oxidant supply valve to halt the flow of the oxidant to the first fuel cell stack in response to the load being less than a threshold so that the first amount of power decreases as a residual amount of oxidant in the first fuel cell stack is reacted. The first power source comprises a first fuel cell stack electrically coupled to the DC bus and operable to output a first amount of power to a load; a first diode electrically coupled between a cathode of the first fuel cell stack and the positive DC voltage rail of the DC bus, and operable to conduct current such that an output voltage of the first fuel cell stack is substantially equal to a voltage of the DC bus; an oxidant supply system fluidly coupled to the first fuel cell stack via at least an oxidant supply valve and operable to selectively supply a flow of an oxidant to the first fuel cell stack; and a fuel recirculation system fluidly coupled to the first fuel cell stack via at least a fuel recirculation valve and operable to supply a flow of a fuel to the first fuel cell stack, wherein the fuel recirculation system maintains the flow of the fuel to the first fuel cell stack while at least a portion of the residual amount of oxidant in the first fuel cell stack is reacted.

In a further aspect, a system for operating the power system comprises a fuel cell stack electrically coupled to a DC bus and operable to output a first amount of power to a load, a power source electrically coupled to the DC bus and operable to output a second amount of power to the load, means for maintaining an output voltage of the fuel cell stack at least equal to a DC voltage of the DC bus when the fuel cell stack is operating, means for halting a flow of an oxidant to the fuel cell stack in response to the load being less than a threshold so that the first amount of power decreases as a residual amount of oxidant in the first fuel cell stack is reacted, means for recirculating a flow of a fuel to the first fuel cell stack while at least a portion of the residual amount of oxidant in the first fuel cell stack is reacted, and means for replacing the decreasing first amount of power from the fuel cell stack by increasing the second amount of power from the power source.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a schematic diagram of a fuel cell system comprising first and second fuel cell stacks and showing an electrical configuration of the fuel cell system according to one illustrated embodiment.

FIG. 2 is a schematic diagram of the fuel cell system of FIG. 1, showing a flow configuration of the fuel cell system according to one illustrated embodiment.

FIG. 3 is a schematic diagram of the fuel cell system of FIG. 1, showing a flow configuration of the fuel cell system according to another illustrated embodiment.

FIG. 4 is graph showing a polarization curve of the fuel cell system of FIGS. 1 and 2 according to one illustrated embodiment.

FIG. 5 is a schematic diagram of a power system to supply power to an external load and/or internal load according to one illustrated embodiment.

FIG. 6 is a schematic diagram of a fuel cell system having a fuel cell stack and battery in parallel powering a load in accordance with an illustrated embodiment of the invention.

FIG. 7 is a schematic diagram of a hybrid fuel cell system embodiment powering a load, the fuel cell system having a fuel cell stack and an ultracapacitor based circuit.

FIG. 8 is a schematic diagram of a number of the fuel cell systems of FIG. 1, electrically coupled to form a combination fuel cell system for powering a load at a desired voltage and current.

FIG. 9 is a schematic diagram of an embodiment of a fuel cell system with a DC/DC converter regulating current of a hibernating fuel cell.

FIG. 10 is a flowchart illustrating an embodiment of a process for operating a fuel cell system.

FIG. 11 is a schematic diagram of the fuel cell system with a plurality of fuel cell stacks.

### DETAILED DESCRIPTION

In the following description, certain specific details are set forth in order to provide a thorough understanding of various embodiments. However, one skilled in the relevant art will recognize that the teachings here may be practiced without one or more of these specific details, or with other methods, components, materials, etc. In other instances, well-known structures associated with fuel. cell systems including the various operating and control components commonly referred to as balance of plant (BOP) have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment of the present fuel cell systems. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The headings provided herein are for convenience only and do not interpret the scope or meaning of the claimed invention.

As noted above, prior fuel cell system designs employed fuel cell stacks designed for maximum power conditions. At idle power conditions, flow was increased to provide sufficient pressure drop for water management. The flows required to generate this pressure drop are large and significantly reduce the efficiency of the fuel cell system. Attempts to reduce these flows and pressure drops have decreased the robustness and reliability of the fuel cell stack under idle conditions.

Relatively large turndown ratios (i.e., max load/idle load) make it difficult to design a fuel cell stack which can supply maximum power without violating system limits (pressure drop, flow, etc.) and run efficiently and robustly at idle power. Operating stacks configured in parallel both electrically and with respect to supply subsystems can advantageously reduce the turndown ratio that the fuel cell stack is required to operate under.

Also, operating a fuel cell stack at higher efficiency operating points is desirable. When one or more fuel cell stacks are operating in a system with another type of power source, some embodiments may elect to use power from the other power source so that a fuel cell stack operating at a relatively inefficient operating point may be placed into a hibernation state, described in greater detail hereinbelow. In other embodiments, when a fuel cell stack would otherwise be operating at a relatively inefficient operating point, output of the fuel cell stack is increased so that the amount of additional output power is stored to the power source. Accordingly, the fuel cell stack operates at a relatively higher efficiency operating point. At some later point in time, output may be reduced and the fuel cell stack placed into the hibernation state. Stored power from the power source may be retrieved as needed.

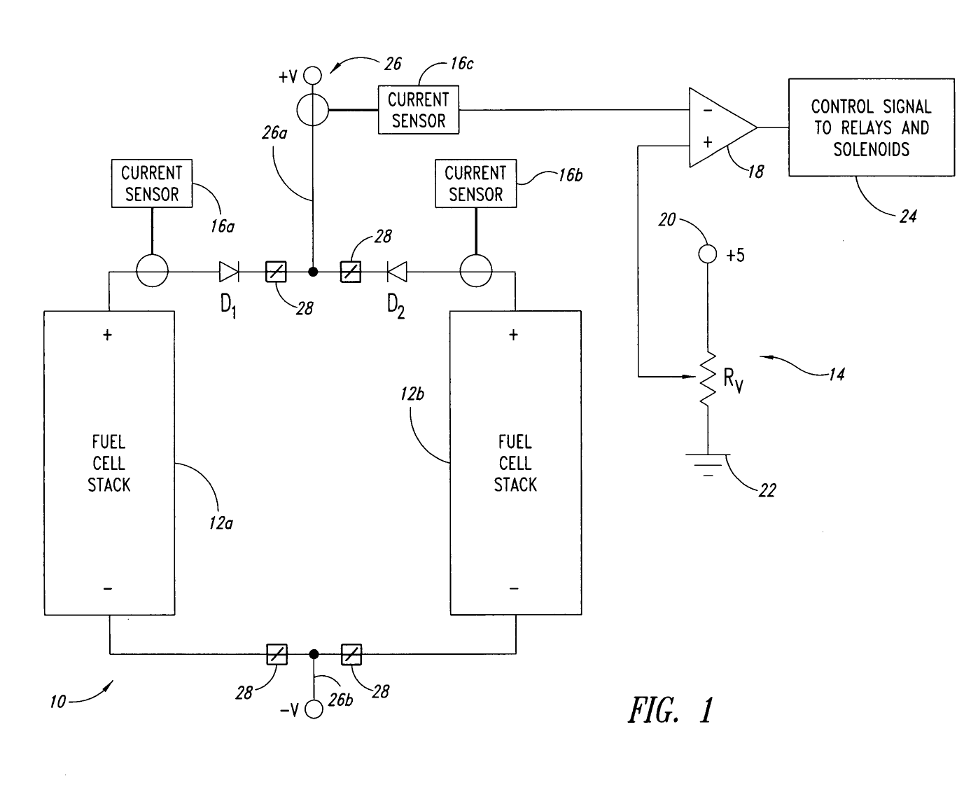

FIG. 1 shows a fuel cell system 10 comprising a first fuel cell stack 12a and a second fuel cell stack 12b electrically coupled in parallel via first and second optional diodes D₁, D₂ to provide a primary voltage source indicated by positive potential +V and negative or ground potential −V. Fuel cell stacks 12a, 12b may be collectively referred to as a fuel cell stacks 12. The fuel cell stacks 12a, 12b may, for example, take the form of Nexa® power modules, available from Ballard Power of Burnaby, B.C., Canada.

An exemplary embodiment of a fuel cell system 10 comprises a control system 14. The exemplary control system 14 is communicatively coupled to a first stack current sensor 16a, a second stack current sensor 16b, and an optional total stack current sensor 16c. The first stack current sensor 16a senses a current produced by the first fuel cell stack 12a, while the second stack current sensor 16b senses a current produced by the second fuel cell stack 12a. The total stack current sensor 16c senses the total current produced by the first and second fuel cell stacks 12.

In some embodiments, the control system 14 further comprises a comparator 18, for example a differential amplifier, coupled to compare the total current sensed by the total stack current sensor 16c to a threshold value. The threshold value may be set via a variable resistor Rv coupled between a voltage source (e.g., +5V) 20 and ground 22. The comparator 18 can provide control signals 24 to relays and/or solenoids, as discussed in more detail below.

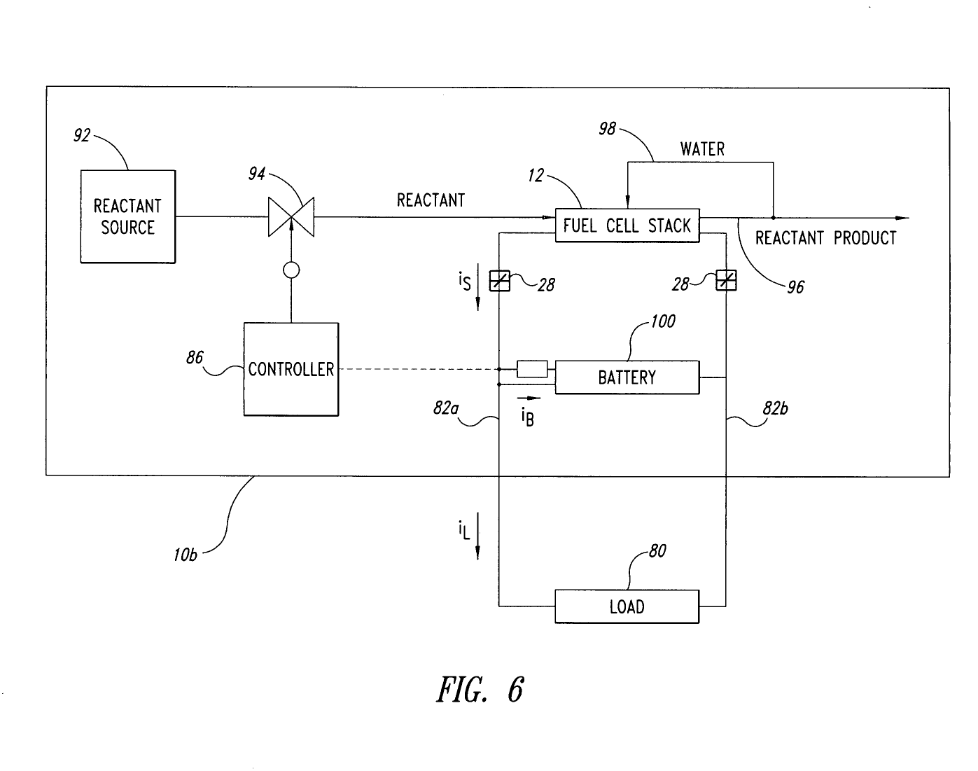

The power sources, such as fuel stacks 12a and/or 12b, are coupled to a positive voltage rail 26 and a negative voltage rail 26b, collectively referred to as a DC bus 26. Contactors 28 provide controllable coupling of the power sources to at least the positive voltage rail 26a and/or negative voltage rail 26b, via control signals from a suitable control device or system, such as controller 86 (FIG. 6).

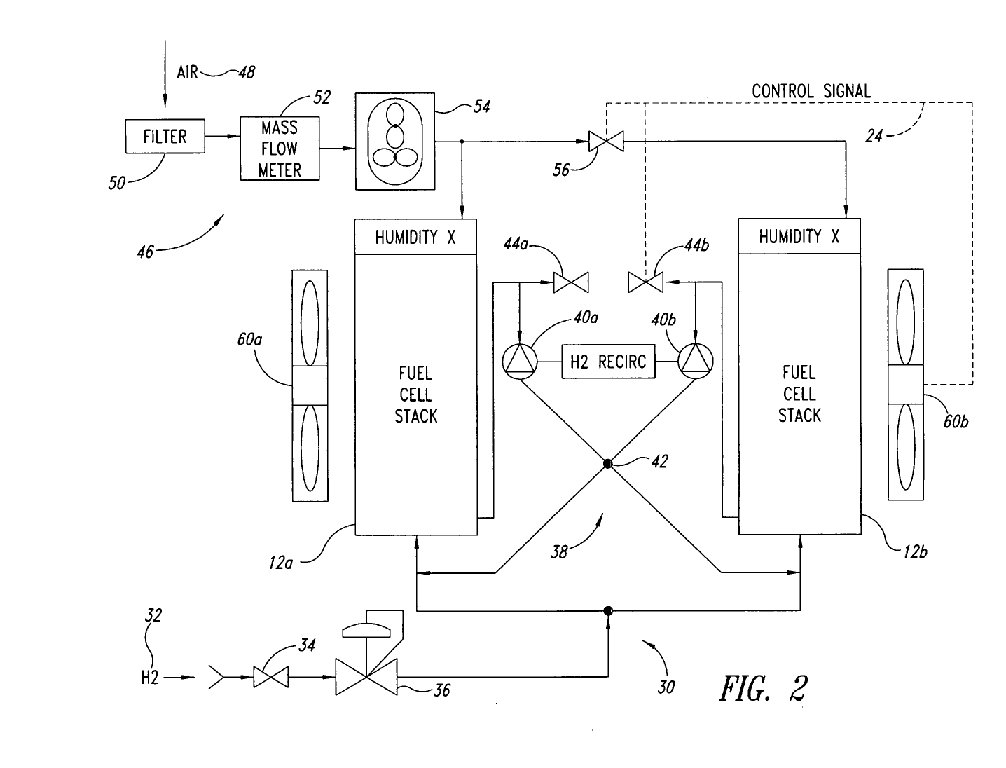

FIG. 2 shows the various supply subsystems of one exemplary embodiment of the fuel cell system 10 of FIG. 1. The fuel cell system 10 comprises a fuel supply subsystem 30 including a fuel source 32, an inlet valve 34, and a regulator 36 to regulate the supply of fuel to the first and second fuel cell stacks 12a, 12b via appropriate conduits and/or manifolds (illustrated by arrows extending between the elements of the fuel supply subsystem 30 and the fuel cell stacks 12). A broad range of reactants can be used in solid polymer electrolyte fuel cells. For example, the fuel stream may be substantially pure hydrogen gas, a gaseous hydrogen-containing reformate stream, or methanol in a direct methanol fuel cell.

Where the fuel used is a fluid, such as pressurized hydrogen, the fuel supply subsystem 30 may advantageously utilize fuel recirculation subsystem 38. The fuel recirculation subsystem 38 of the fuel supply subsystem 30 may comprise one or more fuel delivery devices 40a, 40b such as pumps, compressors and/or blowers. The fuel recirculation subsystem 38 may also comprise one or more mixers 42 to mix recirculated fuel coming from the fuel cell stacks 12 with fuel from the fuel source 32. The fuel recirculation subsystem 38 recirculates the flow of fuel through the fuel cell stack 12. The fuel supply subsystem 30 may comprise one or more purge valves 44a, 44b for purging the anodes of the fuel cell stacks 12.

The fuel cell system 10 may further comprise an oxidant supply subsystem 46 to supply an oxidant, for example oxygen or air, to the fuel cell stacks 12. The oxidant supply subsystem 46 may supply air from a source 48, for example the ambient environment. The oxidant supply subsystem 46 may comprise a filter 50 to filter the air, a mass flow meter 52 to determine a magnitude of the air flow and/or an oxidant delivery device 54 to transfer the air at suitable pressure to the fuel cell stacks 12 via appropriate conduits and/or manifolds (illustrated by arrows extending between the elements of the oxidant supply subsystem 46 and the fuel cell stacks 12). The oxidant delivery device 54 may take the form of a compressor, fan or blower, such as the Roots blower shown schematically in FIG. 2. The air supply subsystem 46 may comprise one or more air supply valves 56, operable to control flow of air to a respective one of the fuel cell stacks 12.

The exemplary embodiment of the fuel cell system 10 may further comprise an optional stack temperature regulating subsystem. The stack temperature regulating subsystem may provide a heat transfer medium to the fuel cell stacks 12 to regulate the temperature of the fuel cell stacks 12 or the ambient environment adjacent the fuel cell stacks 12. The heat transfer medium may take a variety of forms, for example, a fluid such as a liquid and/or a gas. As illustrated, the stack temperature regulating subsystem comprises a first heat transfer medium delivery device 60a and a second heat transfer medium delivery device 60b, each of the heat transfer medium delivery devices 60a, 60b operable to supply a heat transfer medium flow across the fuel cell stacks 12. In some embodiments the heat transfer medium delivery devices 60a, 60b may take the form of fans or blowers operable to blow a stream of air over the fuel cell stacks 12. Alternatively, or additionally, the heat transfer medium delivery devices 60a, 60b may take the form of pumps and/or compressors to direct the heat transfer medium to and/or away from the fuel cell stacks 12. It is noted that while the heat transfer medium is often used to transport heat from the fuel cell stacks 12, in some instances the heat transfer medium may be employed to transport heat to the fuel cell stacks 12, for example during startup of the fuel cell stacks 12.

As illustrated in FIGS. 1 and 2, the fuel cell stacks 12 are configured in parallel, both electrically and with respect to at least the above-described flow subsystems 30, 46. One or more of the air supply valve 56, purge valves 44a, 44b, and heat transfer medium delivery devices 60a, 60b may be responsive to the control signals (indicated by broken line) 24.

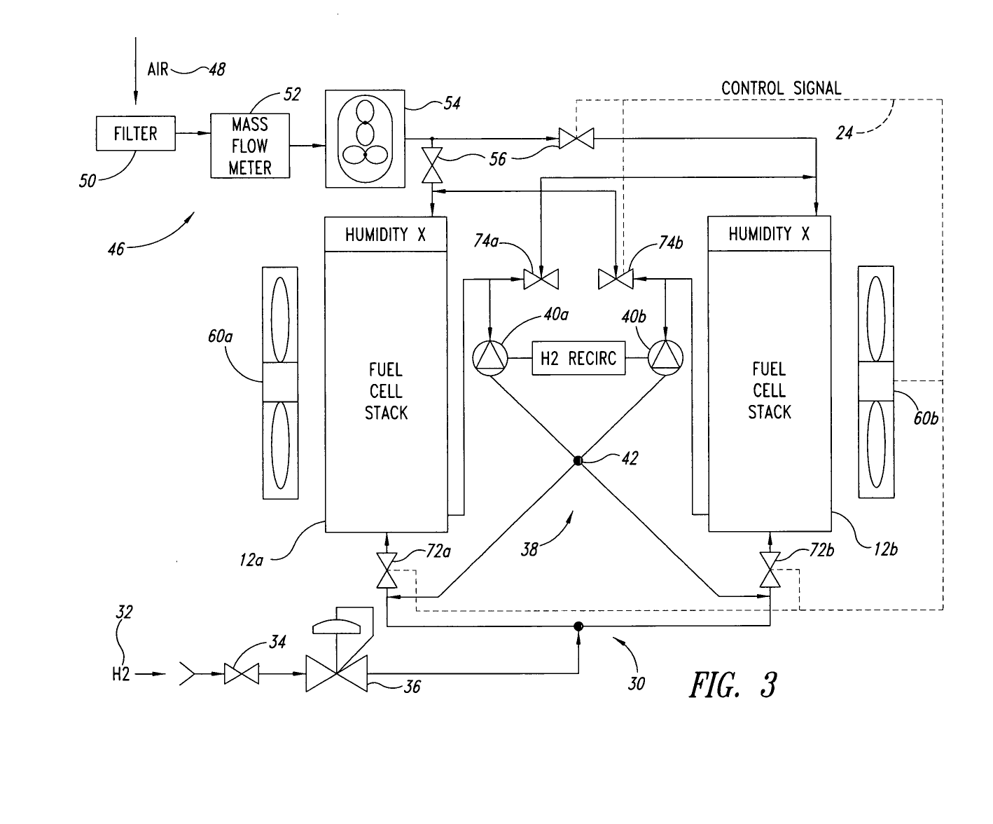

Referring to FIG. 3, in one embodiment, gasses purged from the anodes of the fuel cell stacks 12 may be purged directly to the atmosphere. In another embodiment, gasses purged from the anodes of the fuel cell stacks 12 may be directed into the cathode of at least one of the other fuel cell stacks 12. In yet another embodiment, gasses purged from the anodes of the fuel cell stacks 12 may be directed either to the atmosphere or into the cathode of the other of the fuel cell stacks 12. This may be achieved by use of three way purge valves 74a, 74b. One skilled in the art will appreciate that other valve setups exist that may achieve the same results. Additional devices, such as water separators (not shown) may be used to remove moisture from the purged gasses before their introduction into the cathodes of fuel cell stacks 12.

In another embodiment, the fuel supply subsystem 30 may comprise one or more fuel supply valves 72a, 72b, operable to control flow of fuel to a respective one of the fuel cell stacks 12a, 12b. One or more of the air supply valve 56, fuel supply valves 72a, 72b, purge valves 74a, 74b, and heat transfer medium delivery devices 60a, 60b may be responsive to control signals (indicated by broken line) 24.

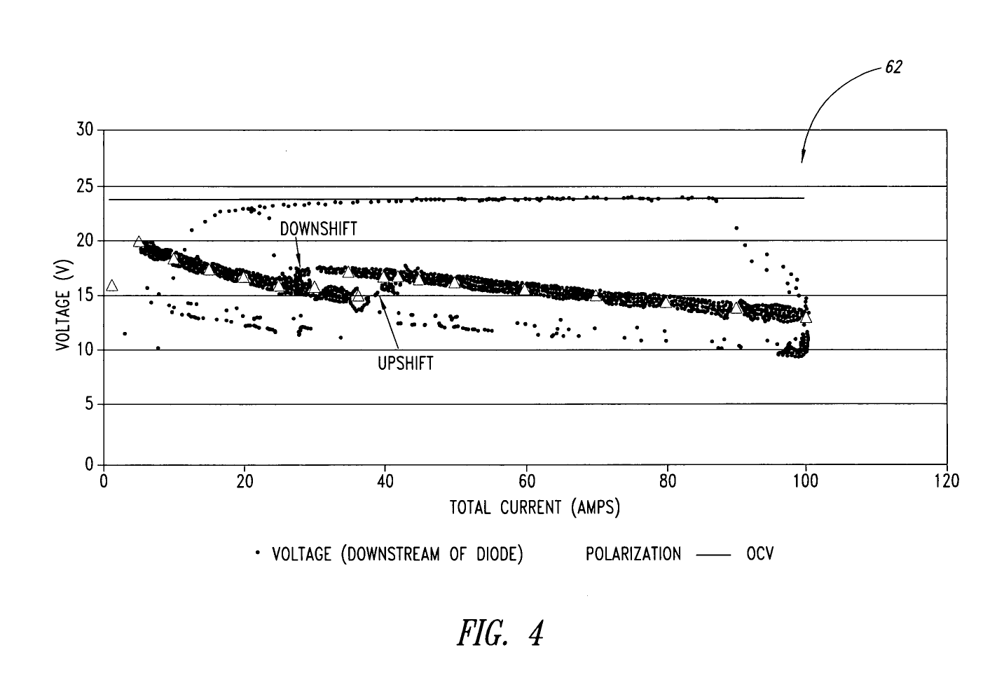

FIG. 4 shows a polarization curve 62 for the fuel cell system 10 topology of FIGS. 1 and 2 employing two 24-cell Nexa® power module fuel cell stacks.

In operation, the fuel cell stacks 12 of the fuel cell system 10 may operate in two states, a hibernation state (also referred to as a non-operational or an idle state) and an operational state (also referred to as a non-idle state). In one embodiment, the hibernation state is triggered when the power demand placed on the fuel cell stack 12 is below a crossover threshold, or another suitable threshold. For example, in some embodiments, the threshold is at or below one half of the maximum power of the fuel cell system 10. The non-idle state is triggered when the power demand placed on the fuel cell system is above the crossover threshold, for example at or above one half of the maximum power of the fuel cell system 10.

In the hibernation state, one of the fuel cell stacks 12, for example the first fuel cell stack 12a, supplies the required power while the other one of the fuel cell stacks 12, for example the second fuel cell stack 12b, does not supply power. That is, the fuel cell stack 12a of this example is in the hibernation state and may be considered as non-operational.

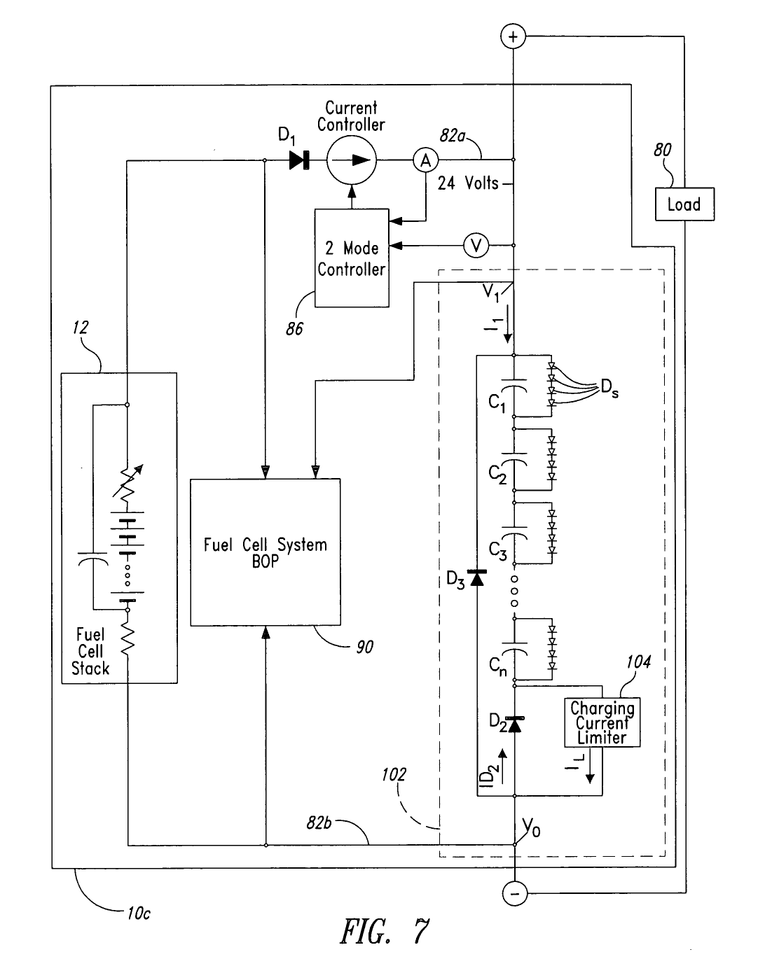

Alternative embodiments, described in greater detail below, may comprise other types of power sources. For example, fuel cell system 10 may include a battery 100 (FIG. 6) and/or super-capacitors 102 (FIG. 7). Rather than operating the fuel cell stack 12 at an inefficient operating point, the fuel cell stack 12 may be operated in the hibernation state while power is sourced from the battery 100 and/or super-capacitors 102. Alternatively, power output of the fuel cell stack 12 may be maintained or even increased, thereby operating the fuel cell stack 12 at an efficient operating point, and the surplus power stored to the battery 100 and/or super-capacitors 102. At some later point, the fuel cell stack 12 could then be operated in the hibernation state while the stored power is retrieved from the battery 100 and/or super-capacitors 102.

The voltage across the fuel cell stack 12, when in the hibernation state, is limited. For example, the voltage of the fuel cell stack 12a when in the hibernation state is limited to be no greater than the voltage across the operating fuel cell stack, for example 12b, through the use of the diodes D₁, D₂. In other embodiments, described in greater detail hereinbelow, the voltage of the fuel cell stack 12a when in the hibernation state is limited to be no greater than the voltage across a direct current (DC) power source that the fuel cell stack 12a is in parallel with.

In other embodiments, diodes D₁, D₂ may be replaced by other devices that perform a similar function. For example diodes D₁, D₂ may be replaced by switches that are controlled to perform similar functions to diodes D₁, D₂. Said switches may be controlled to ensure that the voltage across the hibernating fuel cell stack 12a is limited to be no greater than the voltage across the operating fuel cell stack. Simultaneously, such switches could be controlled to ensure that power (or current) does not flow from the operating stack into the hibernating fuel cell stack 12a.

In another embodiment the switches may be controlled such that the voltage across the hibernating fuel cell stack 12a does not rise to or exceed the open circuit voltage (OCV) of the fuel cell stack 12b. The open circuit voltage in this case is defined as the maximum voltage produced by a fuel cell stack 12 when oxidant and fuel are present in the fuel cell stack 12, and an electrical load is not attached to the fuel cell stack 12. For example, for a proton exchange membrane (PEM) type fuel cell with hydrogen as the fuel and air as the oxidant, the OCV is typically in the range of approximately 0.9V to 1.2V. The switches may preferably be solid state switches such as solid state relays (SSRs), insulated gate bipolar transistors (IGBTs), field effect transistors (FETs), metal oxide semiconductor field effect transistors (MOSFETs), and/or other semiconductor switches. One skilled in the art will appreciate that any suitable switching device, or like controllable devices having similar operating functionality, may be used for this purpose.

In some embodiments, hibernation of the exemplary fuel cell stack 12a is initiated by halting flow of the oxidant to the hibernating fuel cell stack 12a. For example, the respective air supply valve 56 (FIG. 3) would be closed (shut off), thereby halting flow of oxidant (or air) into the cathode of the hibernating fuel cell stack 12a. As the supply of existing oxidant in the cathode is consumed (depleted) by the electricity producing reaction process, power supplied from the hibernating fuel cell stack 12a will decrease. As noted above, the diode coupled to the cathode terminal of the hibernating fuel cell stack 12a maintains voltage of the hibernating fuel cell stack 12a as the oxidant is depleted. Accordingly, power (and current) will decay in response to depletion of the oxidant. At some point in the oxidant depletion process, the hibernating fuel cell stack 12a will no longer be able to maintain its voltage.

By maintaining power supplied from the operational fuel cell stack(s) 12b, total electrical power supplied from the fuel cell system 10 may be maintained at a desired level. For example, total electrical power supplied from the fuel cell system 10 may be controlled to match load requirements and/or to provide charging to other types of DC sources, described in greater detail below, of the fuel cell system 10. Alternatively, other types of DC power sources may be used to provide power to offset the reduced power output from the hibernating fuel cell 12a so as to maintain total power sourced to the load.

In one embodiment, if the hibernation period is of a relatively short duration, the flow of fuel may be maintained to the anode of the hibernating fuel cell stack 12a (and/or the fuel flow path may be recirculated). Or, fuel flow may be halted and the existing fuel in the anode flow fields and fuel flow path may be recirculated to maintain the hibernating fuel cell stack 12a in a ready state or the like so that the hibernating fuel cell stack 12a may be more quickly returned to an operational state. If the hibernation period is of a relatively long duration, fuel may be allowed to be consumed completely and/or flow of the fuel may be halted to the hibernating fuel cell stack 12a.

In some embodiments, oxidant concentration may be monitored and/or determined. In response to sufficient depletion of the oxidant of the hibernating fuel cell stack 12a, flow of the fuel may be halted when the oxidant is depleted or decreases below a threshold. Alternatively, or in addition, in response to sufficient depletion of the fuel of the hibernating fuel cell stack 12a, the fuel recirculation process may be halted.

In other embodiments, fuel recirculation in the hibernating fuel cell stack 12a may continue for a predetermined time after the start of the hibernation process. Upon expiration of the predetermined time, the fuel recirculation may be halted.

In the various embodiments, supply of fuel to the hibernating fuel cell stack 12a may be maintained during the recirculation process, or may be halted at any suitable point during the oxidant depletion process. For example, supply of fuel may be halted after a predetermined time after the start of the hibernation process. (The predetermined time associated with halting supply of fuel need not be the same as the predetermined time associated with halting the fuel recirculation.)

In some embodiments, when one of the fuel cell stacks 12 is in the hibernation state, the fuel may be recirculated through both of the fuel cell stacks 12a, 12b, with a periodic purge via purge valves 44a, 44b (or purge valves 74a, 74b), respectively. However, if the hibernation period is of a relatively long duration as noted above, air is only supplied to the operating one of the fuel cell stacks 12 in order to reduce the possibility of corrosion by limiting the presence of oxygen.

In another embodiment, the gasses purged from the anode of the operating stack may be directed into the cathode of the hibernating fuel cell stack 12a. Supplying fuel to the anode of the hibernating fuel cell stack 12a while not supplying oxidant gasses to the cathode of the hibernating fuel cell stack 12a may result in some fuel loss due to fuel migration across the membrane. Filling the cathode of the hibernating fuel cell stack 12a with fuel purged from the operating fuel cell stack 12b may advantageously reduce this loss.

In another embodiment, fuel supply to the hibernating fuel cell stack 12a may be suspended after air is no longer supplied to the hibernating fuel cell stack 12a. This may further advantageously reduce fuel losses.

In the idle state, the heat transfer medium may or may not be supplied to the hibernating fuel cell stack 12a depending on the rate of heat loss to the environment and the sensitivity of the fuel cell stacks 12 and the fuel cell system 10 to loss of heat and temperature change along the hibernating fuel cell stack 12a.

When the demand for power increases and is approximately equal to the crossover threshold, the previously hibernating fuel cell stack 12a is activated, for example, by supplying air to the fuel cell stack 12a through the air supply valve 56. In operating conditions where fuel has been previously halted to the hibernating fuel cell stack 12a, fuel may be supplied to the anode of the hibernating fuel cell stack 12a before or as the air is supplied through the air supply valve 56.

The electrical power supplied from the previously operating fuel cell stack 12b is reduced to supplying approximately half of the total system power and the restarted hibernating fuel cell stack 12a supplies the remaining approximate half of the total system power. Thus, above the crossover threshold, both fuel cell stacks 12 are operated to each supply approximately half the demanded power.

In one method of operation, the fuel cell system 10 leaves one of the fuel cell stacks 12, for example the fuel cell stack 12b, operating continuously while there is a demand for power without regard to the crossover threshold. In this method the fuel cell system 10 toggles the other one of the fuel cell stacks 12, for example the second fuel cell stack 12a, between the operating and hibernating states based on the comparison of the power demand with the crossover threshold. This approach concentrates the effects of the start/stop process on one of the fuel cell stacks 12.

In another method of operation, the fuel cell system 10 alternates which one of the fuel cell stacks 12 is run continuously and which is toggled from the operational to the hibernating states based on the comparison of the demand with the crossover threshold. This approach may advantageously apportion the wear associated with ON/OFF cycles and/or with operation at low load conditions between the various fuel cell stacks 12.

As an example, in a fuel cell system 20 requiring a maximum current draw of 312A and an idle current draw of 2A, a conventionally designed and operated fuel cell stack 12 would need to be designed so as to operate at 312A and 2A, a load turndown ratio of 156. However, a fuel cell system 10 employing the above described approach, would advantageously employ fuel cell stacks 12 designed to operate at 156A and 2A, halving the load turndown ratio.

In addition to reducing the turndown ratio, the above described approach may provide several other benefits. By effectively doubling the current density on the operating fuel cell stack 12 at low loads below the crossover threshold, the time spent at high cell voltages is reduced. This may advantageously reduce membrane degradation, such as by thinning. This may also advantageously reduce the possibility of high potential based cathode corrosion. Assuming that the start, stop, and hibernation conditions are benign, the life of the total system may be increased by dividing the operational hours at low loads between the two or more fuel cell stacks 12. (Hibernation is the non-power producing state the hibernating stack enters when system power demands are less than the cross-over demand. It may not be the same as an “off” state.)

From a system view, the cutoff of air to the hibernating fuel cell stack 12a increases the pressure drop per unit of flow on the cathode side of the operational fuel cell stack 12b. Assuming that at idle the oxidant delivery device 54 must supply enough airflow to maintain a critical minimum pressure drop, the flow rate to achieve this is approximately half that of a non-switching fuel cell system with the same high power flow/pressure drop characteristics. This can reduce the parasitic load on oxidant delivery device 54 by as much as 50% below the crossover point. Additionally, if the heat transfer medium flow to the hibernating fuel cell stack 12a is also cut off, there is a corresponding reduction in the heat transfer medium delivery device 60a, 60b parasitic load as well, although this reduction may not be as high as 50%.

Finally, electrically coupling multiple fuel cell stacks 12 in parallel increases redundancy. Should one the fuel cell stacks 12 fail, the remaining fuel cell stack 12 is still capable of supplying 50% of maximum power. In some embodiments, the fuel cell system 10 may supply greater than 50% of maximum power where fewer than half of the fuel cell stacks fail. This redundancy allows the fuel cell system 10 to implement a “limp-home” mode that can allow the fuel cell system 10 to continue functioning at a reduced capability until the fuel cell system 10 can be serviced. This may, for example, allow an electric or hybrid vehicle to move to a secure location such as a breakdown lane, a repair shop, and/or operator's home. Additionally, or alternatively, this may allow the backup of data and performance of an orderly shut down routine, for example in either a mobile application or a stationary application.

The fuel cell system 10 may be designed without fuel recirculation subsystem 38 which would reduce complexity and cost, but may reduce fuel efficiency. Each fuel cell stack 12 does not necessarily require a respective purge valve 44a, 44b, again reducing complexity. While the heat transfer medium delivery device 60a, 60b may continue to provide the heat transfer medium to the fuel cell stack 12 after the fuel cell stack 12 ceases producing power, ceasing the flow of the heat transfer medium to the hibernating one of the fuel cell stacks 12 may advantageously maintain a temperature gradient along the flow fields of the hibernating one of the fuel cell stacks 12.

It may be advantageous to maintain more than just binary (e.g., ON/OFF) control over the heat transfer medium (e.g., airflow) between the two fuel cell stacks 12. Having some control over the volume and or speed of the flow of the heat transfer medium between the fuel cell stacks 12 allows for better load and flow balancing. In addition, long periods of non-operation can leave one of the fuel cell stacks 12 colder than the other, and without a temperature gradient (dT) along the length of the flow fields of the hibernating fuel cell stack 12. This adversely affects the pressure drop causing flow sharing inequities when the hibernating fuel cell stack 12is restarted. These flow sharing inequities will also exist between the hibernating fuel cell stack 12 which is starting up and the fuel cell stack 12 which has been operating.

Future automotive systems with high turndown, long life and high reliability requirements could utilize the above described approach. In addition, the redundancy aspects of above described approach may also make it applicable to stationary systems. The ability to turn ON individual fuel cell stacks can be used as part of an exercising routine in fuel cell based systems with low frequency start-up. For example, such an exercise routine may be implemented in an uninterruptible power supply systems (UPS) application, such as a power supply backup for telecommunications switching offices. The above described approach may advantageously prevent cathode corrosion and membrane degradation by not allowing the voltage across the hibernating fuel cell stack 12 to rise to open voltage condition (OVC) when not in use, by using diodes D₁, D₂ between the fuel cell stacks 12 rather than contactors or relays.

Continuous fuel recirculation may also advantageously prevent cathode corrosion due to fuel starvation, minimizing degradation during restarts of the fuel cell stacks 12. The diodes D₁, D₂ allow the voltage across the hibernating fuel cell stack 12 to almost immediately begin to bleed down over time. Transient voltage cathode corrosion may be reduced or eliminated.

As discussed above, some of the advantages may include reduced turndown requirement of the fuel cell stack 12, reduced time spent at high cell voltages and consequently reduced membrane degradation and cathode corrosion. Also as discussed above, some of the advantages may additionally or alternatively include increased total fuel cell system lifetime due to splitting low load hours between multiple fuel cell stacks 12. Some of the advantages may additionally or alternatively include reduced cathode blower parasitic losses at low loads. Some of the advantages may additionally or alternatively include improved redundancy of the fuel cell system 10, for example, provision of a limp-home mode.

While discussed above in terms of a two stack configuration, the fuel cell system 10 may include a greater number of unit fuel cell stacks 12 which may advantageously contribute to decreasing the turndown ratio and increasing the reliability and redundancy.

As used herein the term fuel cell stack 12 refers to one or more fuel cells electrically coupled together that produce a voltage across a pair of nodes or terminals. Thus, in one embodiment, the two or more fuel cell stacks 12 may be distinct stack structures, each a physically separate collection of fuel cells electrically and mechanically coupled together, and each comprising a respective pair of nodes or terminals. In another embodiment, the two or more fuel cell stacks 12 may be portions of a single integral structure with the fuel cells of all fuel cell stacks electrically and mechanically coupled together. In such an embodiment a common tap node or terminal is shared between the fuel cell stacks and thereby divides the structure into two or more portions. The common tap node or terminal may, or may not, be at a center point in the structure.

The foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, such as one or more computer programs running on one or more computers (e.g., as one or more programs running on one or more computer systems), as one or more programs running on one or more controllers (e.g., microcontrollers), as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure. As a non-limiting example, the above-described control system 14 comprising the comparator 18 and/or control signals 24 may be replaced and/or generated by any suitable controller or processing system.

In addition, those skilled in the art will appreciate that the control mechanisms taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

As used herein and in the claims, the terms “set of fuel cells” and/or “fuel cell stack” refer to any number of fuel cells that are electrically coupled to produce a voltage thereacross. While the set of fuel cells will most often be associated with a stack of fuel cells, the fuel cells of the set may, or may not, be mechanically coupled together, and may comprise as few as a single fuel cell. The term “demand for power” refers to a current, voltage or power draw of the load, whether the load comprises the electric machine 14 and/or an intermediary device.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet, including but not limited to:

U.S. Pat. No. 6,573,682, issued Jun. 3, 2003; U.S. patent publication Nos. 2003/0022038, 2003/0022036, 2003/0022040, 2003/0022041, 2003/0022042, 2003/0022037, 2003/0022031, 2003/0022050, and 2003/0022045, all published Jan. 30, 2003; 2003/0113594 and 2003/0113599, both published Jun. 19, 2003; 2004/0009380, published Jan. 15, 2004; and 2004/0126635, published Jul. 1, 2004; U.S. patent application Ser. No. 10/817,052, filed Apr. 2, 2004; Ser. No. 10/430,903, filed May 6, 2003; Ser. No. 10/440,512, filed May 16, 2003; Ser. No. 10/875,797 and Ser. No. 10/875,622, both filed Jun. 23, 2004; Ser. No. 10/664,808, filed Sep. 17, 2003; Ser. No. 10/964,000, filed Oct. 12, 2004; and Ser. No. 10/861,319, filed Jun. 4, 2004; and U.S. provisional patent application Ser. Nos. 60/569,218, filed May 7, 2004; 60/560,755, filed Jun. 4, 2004; 60/621,012, filed Oct. 20, 2004; 60/737,932, filed Nov. 18, 2005; and 60/783,100, filed Mar. 15, 2006, are incorporated herein by reference, in their entirety. Aspects of the present systems and methods can be modified, if necessary, to employ systems, circuits and concepts of the various patents, applications and publications to provide yet further embodiments of the invention.

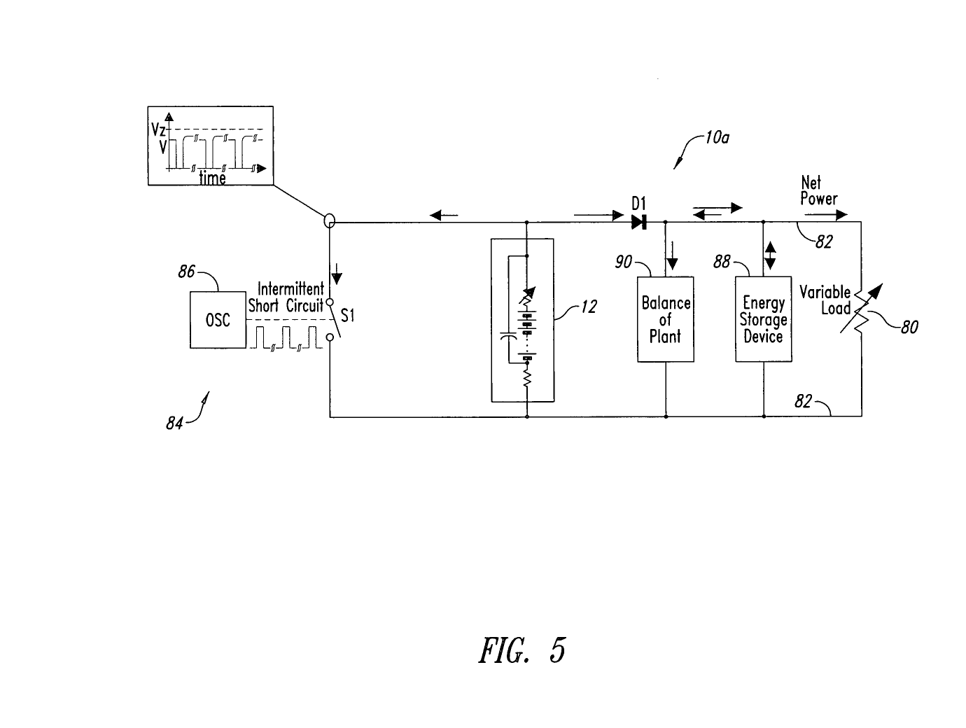

For example, FIG. 5 shows a hybrid fuel cell system 10a according to one illustrated embodiment, providing power to an external load 80. The hybrid fuel cell system 10a comprises a fuel cell stack 12 electrically coupled between rails of a DC power bus 82, a pulsing switch S1 electrically coupled across the fuel cell stack 12, and a controller 84 coupled to control the pulsing switch S1. The controller 84 may take the form of an oscillator 86, providing a simple, inexpensive and reliable circuit for current pulsing in some embodiments. The DC power bus 82, interchangeably referred to as a high voltage bus, has a positive DC (+DC) bus or rail 82a and a negative DC (−DC) bus or rail 82a (FIG. 6).

As illustrated in FIG. 5, in some embodiments the hybrid fuel cell system 10a may further comprise an electrical storage device 88 electrically coupled in parallel with the fuel cell stack 12 to form a hybrid power system 10. In such embodiments, the electrical energy storage device 88 provides current to the load(s) 80, 90 during the time when the stack current is pulsed. In such embodiments, the hybrid fuel cell system 10a may employ a diode D1 to protect the electrical energy storage device 88 from transients, such as those resulting from the short circuiting of the fuel cell stack 12.

The electrical energy storage device 88 may take a variety of forms suitable for storing and releasing stored energy, for example, one or more batteries such as one or more valve regulated lead acid (“VRLA”) batteries 100 (FIG. 6) and/or one or more super-capacitors 102 (FIG. 7). In embodiments where the electrical energy storage device 88 is a VRLA battery 100, for example, voltage variation to the loads 80, 90 may occur during stack current pulsing. In embodiments where the electrical energy storage device 88 is a super-capacitor band 102, such voltage variations may be easily filtered out. In some embodiments, battery 100 is a rechargeable battery cell.

FIG. 6 shows a fuel cell system 10b powering a load 80 according to an alternative embodiment. The fuel cell system 10b includes a fuel cell stack 12 composed of a number of individual fuel cells electrically coupled in series. The fuel cell stack 12 receives reactants, such as hydrogen and air, from a reactant source 92 via a control element such as one or more compressors, pumps, and/or valves 94, or other regulating means. The fuel cell stack 12 produces reactant product represented by arrow 96, typically including water. As represented by arrow 98, some or all of the water may be returned to the fuel cell stack 12 to hydrate the membrane. A battery 100 is electrically coupled in parallel with the fuel cell stack 12 on the rails of high voltage bus 82a, 82b to power the load 80.

In one embodiment, fuel cell system 10b may be operating the fuel cell stack 12 at an inefficient operating point. Or, the amount of power drawn by load 80 could be decreasing such that controller 86 would be required to change the operating point of the fuel cell stack 12 from an efficient operating point to an inefficient operating point.

In such situations, controller 86 monitors operation of the fuel cell stack 12 to determine if inefficient operation of the fuel cell stack 12 is occurring, or will be occurring as output of the fuel cell 12 is adjusted in response to a decrease in the amount of power drawn by load 80. Accordingly, the controller 86 may place the fuel cell stack 12 into the hibernation state and draw power from the battery 100. That is, the decreasing power output from the fuel cell stack is replaced with an increasing power output from the battery 100 such that a total power output sourced to the load 80 is maintained. As noted above, the diode D1 (FIG. 1) allows the fuel cell stack 12 to maintain its output voltage at a value that is substantially equal to the DC voltage of the DC power bus 82 as the fuel cell stack 12 transitions to the hibernating stage.

Alternatively, controller 86 may monitor or determine the storage capacity of the battery 100. If the battery 100 has a sufficient amount of available storage capacity, the controller 86 may operate the fuel cell stack 12 at the same output, or even at a higher output, and store excess power output from the fuel cell stack 12 into the battery 100. That is, power output in excess of power provided to the load 80 is stored into the battery 100 for later use. Accordingly, the fuel cell stack 12 continues to operate efficiently. At some later point, such as when the battery 100 is fully charged, controller 86 operates the fuel cell stack 12 in the hibernation state while stored power is retrieved from the battery 100.

As noted above, controller 86 compares output of the fuel cell 12 with a threshold, such as the crossover threshold or another suitable threshold. In some embodiments, the threshold is used as a demarcation between efficient and inefficient fuel cell stack operation. Accordingly, the controller 86 monitors output DC power and/or current of the fuel cell stack 12, and compares the monitored DC power and/or current to the power threshold or current threshold, respectively, to determine if the fuel cell stack 12 is operating efficiently or inefficiently.

FIG. 7 shows another embodiment of a hybrid fuel cell system 10c operable to power an external load 80. In contrast to the previously discussed embodiments, the fuel cell system 10c of FIG. 7 employs an ultracapacitor circuit 102 as an electrical power energy storage device 88 (FIG. 5), the ultracapacitor circuit 102 being configured to simulate a battery 100 (FIG. 6).

The ultracapacitor circuit 102 comprises a number of ultracapacitors C₁-Cₙ electrically coupled in series between the rails 82a, 82b of the voltage bus. A charging current limiter 104 is electrically coupled in series with the ultracapacitors C₁-Cₙ to limit charging current to the ultracapacitors C₁-Cₙ. A bypass diode D₂ is electrically coupled across the charging current limiter 104 to provide a path for discharge current which bypasses the charging current limiter 104. A reverse charging diode D₃ prevents the ultracapacitors C₁-Cₙ from charging in the reverse direction, for example, when connected in series with other electrical power energy storage devices 88 or hybrid fuel cell systems 10a, 10b, and/or 10c.

Fuel cell system 10c may be operating the fuel cell stack 12 at an inefficient operating point. Or, the amount of power drawn by load 80 could be decreasing such that controller 86 would be required to change the operating point of the fuel cell stack 12 from an efficient operating point to an inefficient operating point. In such situations, controller 86 may operate to place the fuel cell stack 12 into the hibernation state and draw power from the ultracapacitor circuit 102. As noted above, the diode D1 (FIG. 1) allows the fuel cell stack 12 to maintain its output voltage at a Value that is substantially equal to the DC voltage of the DC power bus 82 as the fuel cell stack 12 transitions to the hibernating stage.

Alternatively, controller 86 may monitor the storage capacity of the ultracapacitor circuit 102. If the ultracapacitor circuit 102 has sufficient available storage capacity, the controller 86 may operate the fuel cell stack 12 at the same output, or at a higher output, and store excess power output from the fuel cell stack 12 into the ultracapacitor circuit 102. Accordingly, the fuel cell stack 12 continues to operate efficiently. At some later point, such as when the ultracapacitor circuit 102 is fully charged, controller 86 would operate the fuel cell stack 12 in the hibernation state while stored power is retrieved from the ultracapacitor circuit 102. That is, the decreasing power output from the fuel cell stack is replaced with an increasing power output from the ultracapacitor circuit 102 such that a total power output sourced to the load is maintained.

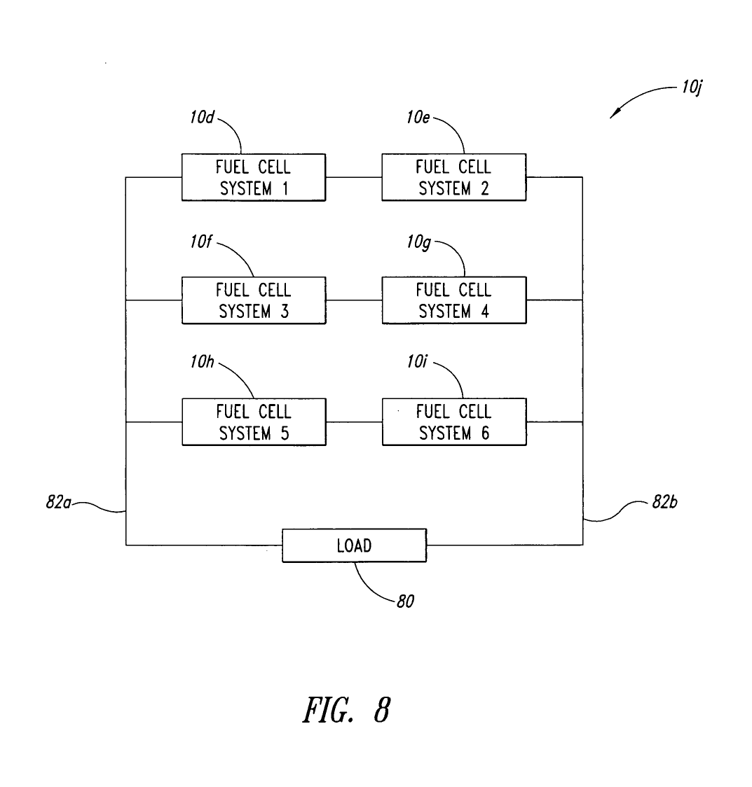

FIG. 8 shows a number of fuel cell systems 10d-10i, electrically coupled to form a combined fuel cell system 10j, for powering the load 80 at a desired voltage and current. The fuel cell systems 10d-10i can take the form of any of the fuel cell systems 10, 10a, 10b, or 10c discussed above.

FIG. 8 shows only one possible arrangement. One skilled in the art will recognize that other arrangements for achieving a desired voltage and current are possible. A combined fuel cell system 10j may include a lesser or greater number of individual fuel cell systems 10d-10i than illustrated in FIG. 8. Other combinations of electrically coupling numbers of individual fuel cell systems 10 can be used to provide power at other desired voltages and currents. For example, one or more additional fuel cell systems (not shown) can be electrically coupled in parallel with one or more of the fuel cell systems 10d-10e. Additionally, or alternatively, one or more additional fuel cell systems (not shown) can be electrically coupled in series with any of the illustrated pairs of fuel cell systems 10d:10e, 10f:10g, 10h:10i. Further, the fuel cell systems 10d-10i may have different voltage and/or current ratings. The individual fuel cell systems 10d-10i can be combined to produce an “n+1” array, providing a desired amount of redundancy and high reliability.

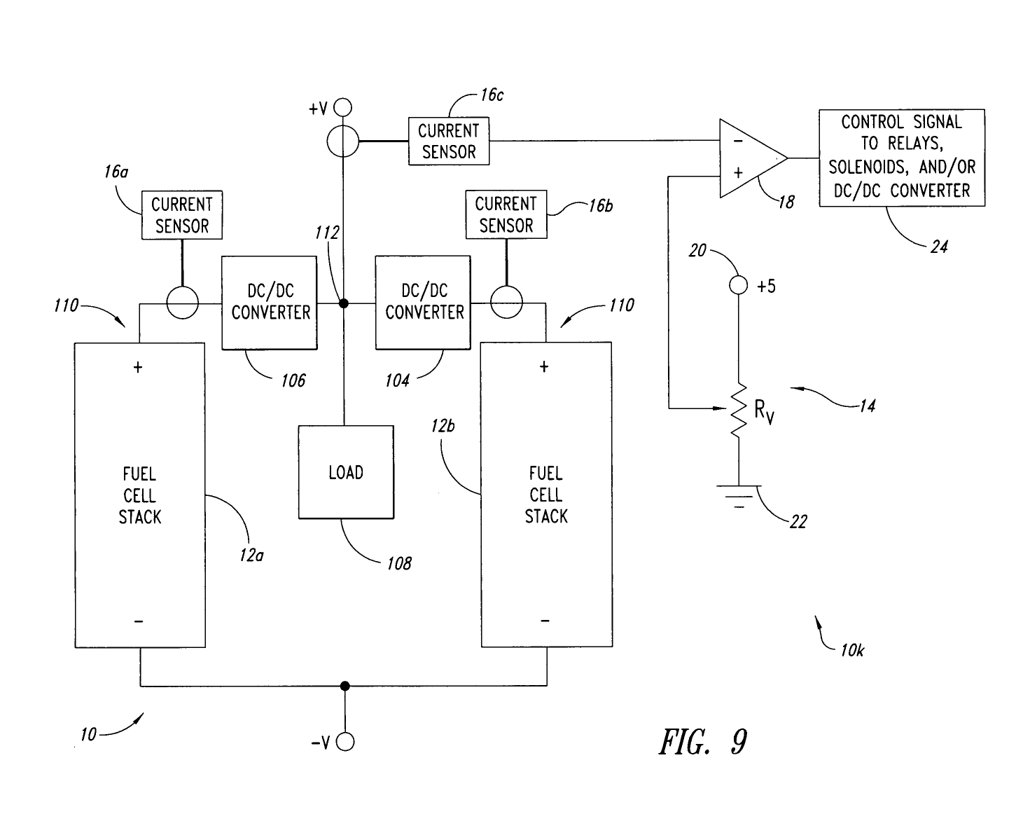

FIG. 9 is a schematic diagram of an embodiment of a fuel cell system 10k with a direct current to direct current (DC/DC) converter 104 regulating current of a hibernating fuel cell stack 12a. An alternative embodiment comprises a second optional DC/DC converter 106 to regulate at least current of the fuel cell stack 12b when the fuel cell stack 12a is operated in a hibernation mode.

The DC/DC converter 104, electrically coupled to the cathode 110 of a fuel cell stack 12, modulates current from the hibernating fuel cell stack, such as fuel cell stack 12a, again referring to the above-described example, so that as the fuel cell stack 12a enters into the hibernating operation mode, fuel cell stack voltage is maintained at a desired voltage level, such as a voltage threshold. For example, the fuel cell stack voltage may be operated at or near a desired voltage level as the oxidant is depleted.

Further, the hibernating fuel cell stack 12a could be directly coupled to at least one load 108, optionally via a controllable switching system 112, such as the above-described contactors 26 (FIG. 1). Thus, load 108 draws the fuel cell stack current from the hibernating fuel cell stack 12a to limit the fuel cell stack voltage to below the open circuit voltage as the fuel cell stack 12a hibernates. It is appreciated that any suitable switching system 112, including a plurality of switches, contactors 26 or the like, may be used to controllably couple the load 108 to a hibernating fuel cell stack 12a.

In the above-described embodiments where fuel cell stacks 12 alternatively hibernate, the second DC/DC converter 106 could be used to modulate the current of the fuel cell stack 12b when it hibernates. Similarly, the fuel cell stack 12b could be optionally coupled to the load 108, as described above.

The above-described embodiments may be operable to reduce the time that a hibernating fuel cell stack 12a is operating at or near its OCV. Operating a fuel cell stack 12a near its OCV may have undesirable effects on the fuel cell stack 12a, as described hereinabove.

Further, average vehicle power noise may be reduced when one or more fuel cell stacks 12 are operating in a hibernating mode. For example, a power reduction and/or shutting down of various flow control devices, such as fans and/or pumps, may result in relatively more quiet operation (as contrasted to traditional systems which are required to maintain the BOP loads).

As noted above, fuel cell membranes may be comprised of finely comminuted platinum at each membrane electrode interface to induce the desired electrochemical reaction. By placing one or more fuel cell stacks 12 in hibernation, the amount of platinum oxide formation may be reduced, depending upon hibernation cell voltages.

As illustrated in FIG. 8, a plurality of fuel cell stacks 12 may be employed. Depending upon load requirements, a plurality of fuel cell stacks 12 may be hibernated. Furthermore, if load continues to decrease, additional fuel cell stacks 12 may be hibernated as needed such that operational fuel cell stacks 12 are efficiently operated. As load increases, hibernating fuel cell stacks 12 may be restarted as needed. In such systems, a controller 86 or other suitable processing system may be used to control the hibernation process.

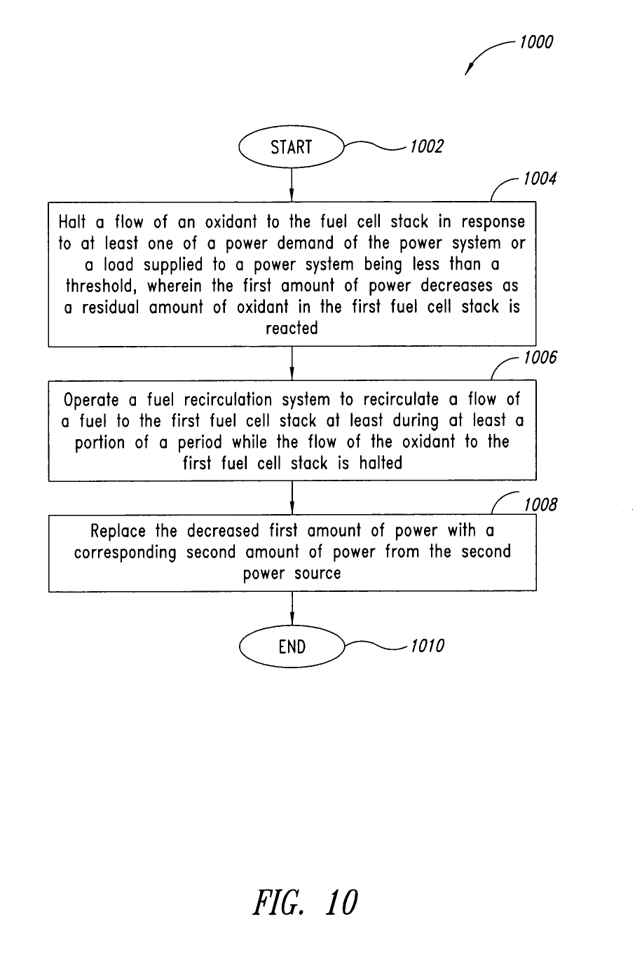

FIG. 10 is a flowchart 1000 illustrating an embodiment of a process for operating a fuel cell system 10 (FIGS. 1-3, 5-9 and 12). It should be noted that in some alternative embodiments, the functions noted in the blocks may occur out of the order noted in FIG. 10, may include additional functions, and/or may omit some functions. For example, two blocks shown in succession in FIG. 10 may in fact be executed substantially concurrently, the blocks may sometimes be executed in the reverse order, or some of the blocks may not be executed in all instances, depending upon the functionality involved, as will be further clarified hereinbelow. All such modifications and variations are intended to be included herein within the scope of this disclosure.

The process illustrated in the flow chart 1000 starts at block 1002. A flow of an oxidant to the first fuel cell stack is halted in response to at least one of a power demand of the power system or a load supplied to a power system being less than a threshold, wherein the first amount of power decreases as a residual amount of oxidant in the first fuel cell stack is reacted at block 1004. A fuel recirculation system is operated to recirculate a flow of a fuel to the first fuel cell stack at least during at least a portion of a period while the flow of the oxidant to the first fuel cell stack is halted at block 1006. The decreased first amount of power is replaced with a corresponding second amount of power from the second power source at block 1008. The process ends at block 1010.

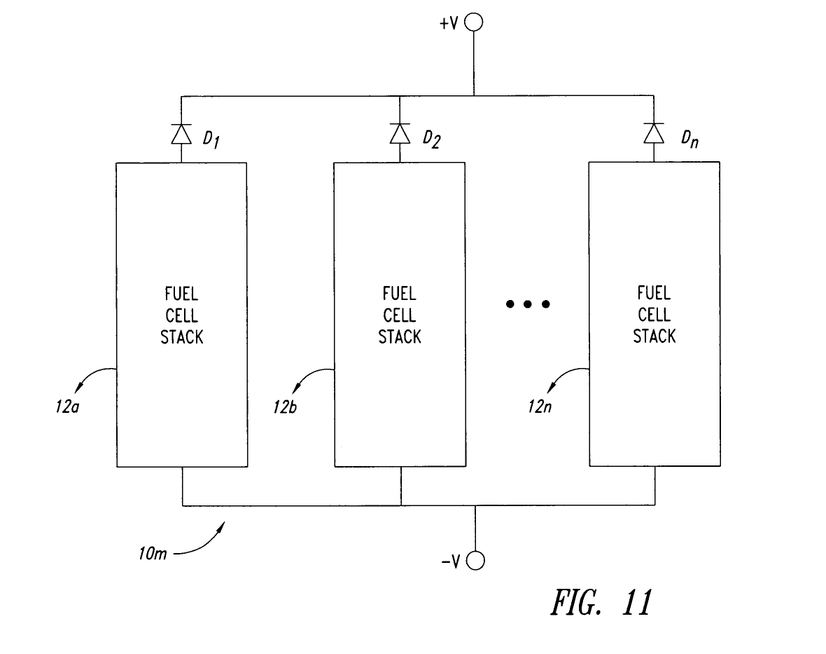

FIG. 11 illustrates an alternative embodiment with a plurality of fuel cell stacks 12b-12n (collectively referred to as fuel cell stacks 12). Here, a third fuel cell stack 12c is operated at some current. A new total current is determined after the fuel cell stack 12a is hibernating. Here, the new total current is equal to a sum of the new current of the fuel cell stack 12b and the current of the fuel cell stack 12c. In response to the new total current equaling less than half of the maximum current of the fuel cell stack 12b, flow of the oxidant to the third fuel cell stack 12c is halted and the recirculation of the flow of the reactant to the third fuel cell stack 12c is maintained. These and other changes can be made to the present systems and methods in light of the above-detailed description. In general, in the following claims, the terms used should not be construed to limit the invention to the specific embodiments disclosed in the specification and the claims, but should be construed to include all power systems and methods that read in accordance with the claims. Accordingly, the invention is not limited by the disclosure, but instead its scope is to be determined entirely by the following claims.

1. A method of operating a power system comprising at least a first power source and a second power source, wherein the first power source and the second power source are electrically coupled in parallel to one another via a direct current (DC) power bus, wherein the first power source is a first fuel cell stack, and wherein a cathode of the first fuel cell stack is coupled to a positive DC voltage portion of the DC power bus via a first diode, the method comprising:
halting a flow of an oxidant to the first fuel cell stack in response to at least one of a power demand of the power system or a load supplied to a power system being less than a threshold, wherein the first amount of power decreases as a residual amount of oxidant in the first fuel cell stack is reacted;
operating a fuel recirculation system to recirculate a flow of a fuel to the first fuel cell stack at least during at least a portion of a period while the flow of the oxidant to the first fuel cell stack is halted; and
replacing the decreased first amount of power with a corresponding second amount of power from the second power source.

2. The method of claim 1, further comprising:
conducting a current through the first diode such that an output voltage of the first fuel cell stack is substantially equal to a voltage of the second power source.

3. The method of claim 1 wherein prior to halting the flow of the oxidant to the first fuel cell stack, the method comprises:
circulating an additional amount of reactant to the first fuel cell stack to increase the first amount of power; and
storing at least a portion of the increased first amount of power in the second power source.

4. The method of claim 3, further comprising:
charging the second power source from the portion of the increased first amount of power.

5. The method of claim 3 wherein storing at least the portion of the increased first amount of power in the second power source includes storing at least the portion of the increased amount of power in at least one battery.

6. The method of claim 3 wherein storing at least the portion of the increased first amount of power in the second power source includes storing at least the portion of the increased amount of power in at least one ultracapacitor.

7. The method of claim 1, further comprising:
operating a fuel supply system to halt a flow of fuel to the first fuel cell stack in response to halting the flow of the oxidant in the first fuel cell stack.

8. The method of claim 1, further comprising:
halting recirculation of the flow of the fuel to the first fuel cell stack in response to a depletion of the residual amount of oxidant in the first fuel cell stack.

9. The method of claim 1, further comprising:
halting a flow of a coolant from a coolant system to the first fuel cell stack while the flow of the oxidant to the first fuel cell stack is halted.

10. The method of claim 1, further comprising:
supplying oxidant to increase the first amount of power from the first fuel cell stack in response to an amount of the load increasing to at least the threshold, wherein the first amount of power increases as the supplied oxidant in the first fuel cell stack is reacted.

11. The method of claim 1, further comprising:
supplying oxidant to the first fuel cell stack in response to a power output of the second power source decreasing to below an amount of power drawn by the load.

12. The method of claim 11, further comprising:
increasing a DC voltage of the second power source to approximately an open circuit voltage of the first fuel cell stack so that an initial amount of current does not flow from the first fuel cell stack until an operating voltage of the first fuel cell stack is at least equal to the increased DC voltage of the second power source.

13. The method of claim 1, further comprising:
modulating a DC current drawn from the first fuel cell stack via a DC/DC converter such that an output voltage of the first fuel cell stack equals a voltage threshold.

14. The method of claim 1 wherein the second power source is a second fuel cell stack and wherein replacing the decreased first amount of power with the corresponding second amount of power comprises:
operating a fuel supply system to circulate an additional amount of fuel to the second fuel cell stack to increase the second amount of power.

15. The method of claim 1 wherein halting the flow of the oxidant includes closing an oxidant supply valve.

16. A power system, comprising:
a direct current (DC) bus with a positive DC voltage rail;
a first power source comprising:
a first fuel cell stack electrically coupled to the DC bus and operable to output a first amount of power to a load;
a first diode electrically coupled between a cathode of the first fuel cell stack and the positive DC voltage rail of the DC bus, and operable to conduct current such that an output voltage of the first fuel cell stack is substantially equal to a voltage of the DC bus;
an oxidant supply system fluidly coupled to the first fuel cell stack via at least an oxidant supply valve and operable to selectively supply a flow of an oxidant to the first fuel cell stack; and
a fuel recirculation system fluidly coupled to the first fuel cell stack via at least a fuel recirculation valve and operable to supply a flow of a fuel to the first fuel cell stack;
a second power source electrically coupled to the DC bus and operable to output a second amount of power to the load; and
a controller controllably coupled to the oxidant supply valve and the fuel recirculation valve, and operable to close the oxidant supply valve to halt the flow of the oxidant to the first fuel cell stack in response to the load being less than a threshold so that the first amount of power decreases as a residual amount of oxidant in the first fuel cell stack is reacted,
wherein the fuel recirculation system maintains the flow of the fuel to the first fuel cell stack while at least a portion of the residual amount of oxidant in the first fuel cell stack is reacted.

17. The power system of claim 16 wherein the second power source is an energy storage device.

18. The power system of claim 17, further comprising:
a fuel system communicatively coupled to the controller, fluidly coupled to the first fuel cell stack and operable to selectively supply an amount of new fuel to the first fuel cell stack,
wherein the controller, at least for a period of time prior to closing the oxidant supply valve, operates the fuel system to increase the amount of new fuel to the first fuel cell stack to increase the amount of power produced to recharge the energy storage device.

19. The power system of claim 18 wherein the second power source comprises:
at least one rechargeable battery cell.

20. The power system of claim 18 wherein the second power source comprises:
at least one ultracapacitor.

21. The power system of claim 16 wherein the second power source comprises:
a second fuel cell stack electrically coupled to the DC bus and operable to output the second amount of power; and
a second diode electrically coupled between a cathode of the second fuel cell stack and the positive DC voltage rail of the DC bus, and operable to operable to conduct current such that an output voltage of the second fuel cell stack is substantially equal to the voltage of the DC bus.

22. The power system of claim 16, further comprising:
a direct current to direct current (DC/DC) converter electrically coupled to the first fuel cell stack and operable to regulate at least a current of the first fuel cell stack such that the output voltage of the first fuel cell stack equals a voltage threshold.

23. The power system of claim 16 wherein the first power source further comprises:
a contactor coupled between the cathode of the first fuel cell stack and the positive DC voltage rail of the DC bus, and operable in a closed position such that the residual amount of oxidant entering the first fuel cell stack is reacted after the oxidant supply valve is closed to halt the flow of the oxidant to the first fuel cell stack.

24. The power system of claim 23 wherein the first power source further comprises:
at least one load device operable to electrically couple to the first fuel cell stack in response to operating the contactor in an open position, wherein the at least one load device draws a load current from the first fuel cell stack to limit the output voltage of the first fuel cell stack to at least less than an open circuit voltage.

25. A power system, comprising:
a fuel cell stack electrically coupled to a DC bus and operable to output a first amount of power to a load;
a power source electrically coupled to the DC bus and operable to output a second amount of power to the load;
means for maintaining an output voltage of the fuel cell stack at least equal to a DC voltage of the DC bus when the fuel cell stack is operating;
means for halting a flow of an oxidant to the fuel cell stack in response to the load being less than a threshold so that the first amount of power decreases as a residual amount of oxidant in the first fuel cell stack is reacted;
means for recirculating a flow of a fuel to the first fuel cell stack while at least a portion of the residual amount of oxidant in the first fuel cell stack is reacted; and
means for replacing the decreasing first amount of power from the fuel cell stack by increasing the second amount of power from the power source.

26. The power system of claim 25, further comprising:
means for increasing the first amount of power from the fuel cell stack before the means for halting the flow of the oxidant to the fuel cell stack operates such that a portion of increased output is stored into the second power source.
